(19) United States
(12) Patent Application Publication
(10) Pub. No.: US 2015/0174763 A1
(43) Pub. Date: Jun. 25, 2015

(54) DETECTION SYSTEM AND DETECTION METHOD

(71) Applicant: KABUSHIKI KAISHA YASKAWA DENKI, Kitakyushu-shi (JP)

(72) Inventors: Yoshiki KIMURA, Kitakyushu-shi (JP); Takashi MINAMI, Kitakyushu-shi (JP)

(73) Assignee: KABUSHIKI KAISHA YASKAWA DENKI, Kitakyushu-shi (JP)

(21) Appl. No.: 14/555,581

(22) Filed: Nov. 27, 2014

(30) Foreign Application Priority Data
Dec. 19, 2013 (JP) 2013-262088

(51) Int. Cl. B25J 9/16; G01D 5/34

(52) U.S. Cl. CPC B25J 9/1697; G01D 5/342; Y10S 901/47; Y10S 901/30

(57) ABSTRACT

A detection system includes: a rotator that causes a mounting base where a circular substrate is to be mounted to rotate around a rotation axis; a detector that detects presence or absence of an outer peripheral portion of the rotating substrate at a plurality of respective detecting positions having different distances from the rotation axis; and a determiner that determines an eccentric state of the substrate based on detection information, the detection information being a combination of a phase of the mounting base when the presence or absence of the outer peripheral portion is switched and the detecting positions.

### CROSS-REFERENCE TO RELATED APPLICATION

This application claims priority from Japanese Patent Application No. 2013-262088 filed with the Japan Patent Office on Dec. 19, 2013, the entire content of which is hereby incorporated by reference.

### BACKGROUND

1. Technical Field

Embodiments of this disclosure relate to a detection system and a detection method.

2. Description of the Related Art

Conventionally, to align a substrate such as a semiconductor wafer, there is known a detection system that detects the orientation and the position of the substrate.

This detection system, for example, includes a table that rotates a circular substrate, a light source, and a charge coupled device (CCD) sensor.

Here, the substrate may be mounted on the table with being eccentric from the rotation axis of the table. In view of this, to reliably detect an outer peripheral portion of the substrate, a CCD line sensor, which includes a plurality of elements arranged in the radial direction of the table, and a plurality of light sources are employed (for example, see Japanese Patent No. 3528785).

### SUMMARY

A detection system includes: a rotator that causes a mounting base where a circular substrate is to be mounted to rotate around a rotation axis; a detector that detects presence or absence of an outer peripheral portion of the rotating substrate at a plurality of respective detecting positions having different distances from the rotation axis; and a determiner that determines an eccentric state of the substrate based on detection information, the detection information being a combination of a phase of the mounting base when the presence or absence of the outer peripheral portion is switched and the detecting positions.

### BRIEF DESCRIPTION OF THE DRAWINGS

FIG. 1 is a pattern diagram illustrating a sequence of detection operations by a detection system according to an embodiment;

FIG. 2 is a pattern diagram illustrating an arrangement of the detection system;

FIG. 3A is a perspective view illustrating a configuration of a robot;

FIG. 3B is a perspective view illustrating a configuration of a hand;

FIG. 4 is a block diagram of the detection system;

FIG. 5A illustrates detecting positions of the detection system;

FIG. 5B shows an example of a relationship between a phase and a distance from a rotational center to an outer circumference of a wafer;

FIG. 5C illustrates an example of an eccentric state of the wafer;

FIG. 6 illustrates a (first) modification of the detection method;

FIG. 7 illustrates a (second) modification of the detection method;

FIG. 8 illustrates another detection example of a detector;

FIG. 9 is a flowchart illustrating a process procedure performed by the detection system; and

FIG. 10 is a flowchart illustrating a process procedure for determination of the outer peripheral portion of the wafer.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A detection system according to one aspect of the embodiment includes a rotator, detectors, and a determiner. The rotator rotates a mounting base, on which a circular substrate is mounted, around its rotation axis. The detectors detect the presence or absence of an outer peripheral portion of the rotating substrate at the plurality of respective detecting positions having different distances from the rotation axis. The determiner determines an eccentric state of the substrate based on detection information. The detection information is constituted of a combination of the phase of the mounting base when the presence or absence of the outer peripheral portion is switched and the detecting positions.

According to one aspect of the embodiment, the eccentric state of the substrate can be reliably detected at low cost.

The following describes in detail embodiments of a detection system and a detection method disclosed in this application with reference to the accompanying drawings. It is noted that the following embodiments do not limit the technical content of this disclosure.

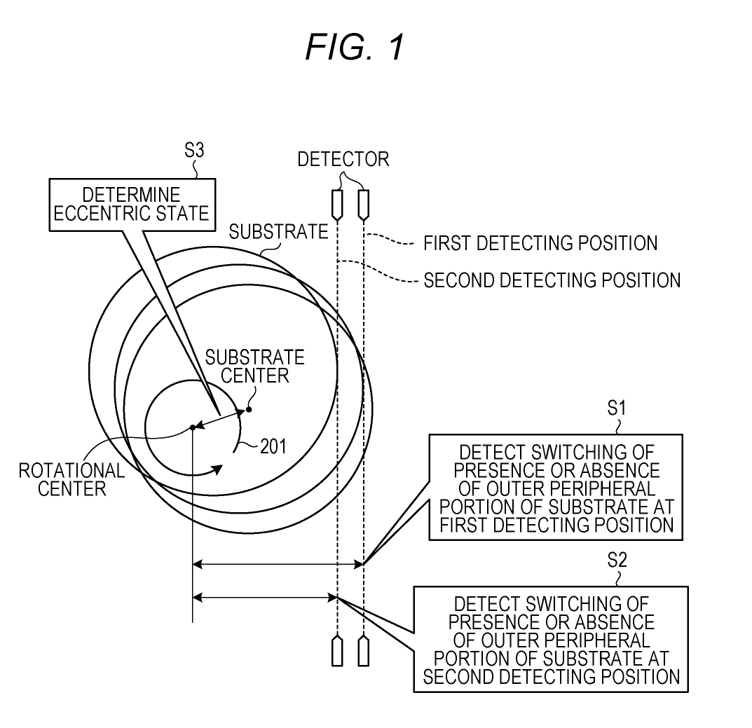

First, the following describes a method for detecting an eccentric state of a substrate by a detection system according to the embodiment with reference to FIG. 1. FIG. 1 is a pattern diagram illustrating a sequence of detection operations by the detection system according to the embodiment. FIG. 1 exaggeratingly illustrates the eccentric state of the substrate with respect to a rotational center for easy understanding of the description.

As illustrated in FIG. 1, the detection system according to the embodiment includes a rotator (not illustrated) and a detector. The rotator rotates a circular substrate around its rotational center. The detector is a sensor that detects switching of presence or absence of an outer peripheral portion of the substrate. Here, the detector is, for example, an optical sensor that includes a light projecting portion and a light receiving portion. When the substrate blocks an optical path formed between the light projecting portion and the light receiving portion, the detector senses that the substrate is in a state of “presence.”

As illustrated in FIG. 1, in the detection system according to the embodiment, the detector detects, at a first detecting position, the switching of the presence or absence of the outer peripheral portion of the substrate rotating, for example, in an arrow 201 direction around the rotational center (Step S1).

The detector further detects the switching of the presence or absence of the outer peripheral portion of the substrate at a second detecting position (Step S2). The second detecting position has a distance from the rotational center different from that of the first detecting position. Then, based on the above-described detecting positions and a rotation position of the substrate (phase of the rotator) when the presence and absence of the outer peripheral portion of the substrate are switched from one to another, the detection system determines the eccentric state of the substrate center with respect to the rotational center (Step S3).

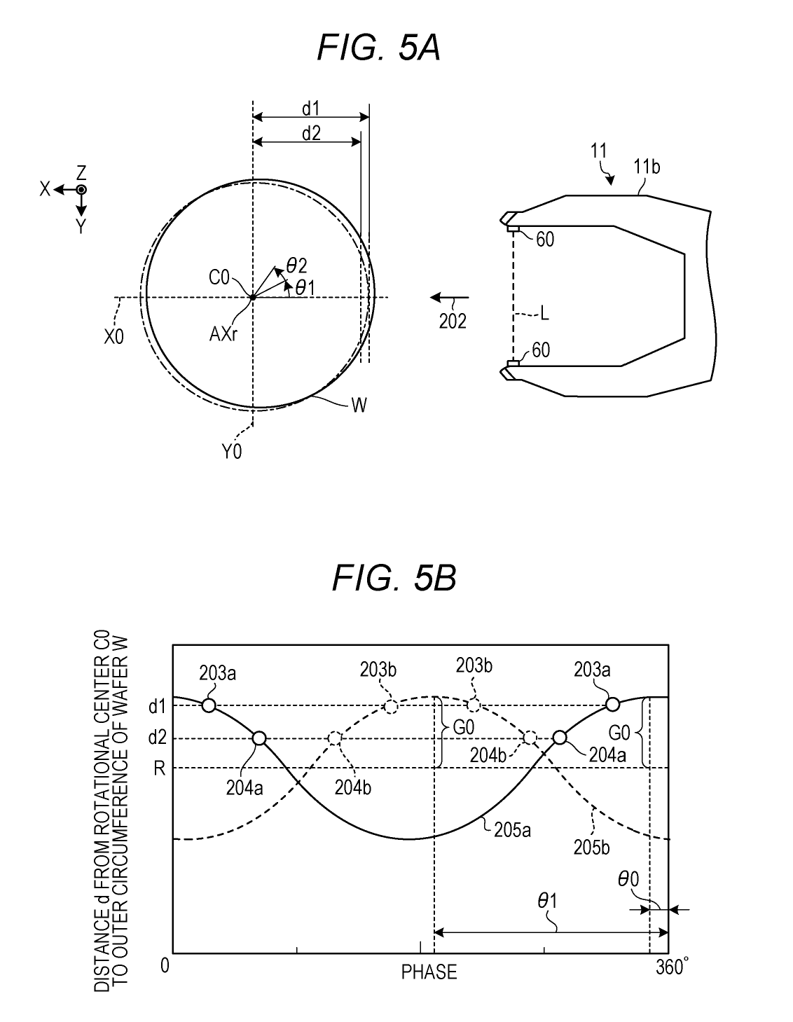

Specifically, the detection system determines an eccentric direction and an amount of eccentricity of the substrate with respect to the rotational center from detection information. The detection information is constituted of a combination of the phase of the rotator and the detecting positions. The details of this respect will be described later with reference to FIG. 5A to FIG. 5C.

Thus, the detection system according to the embodiment, for example, uses a low-price sensor, such as an optical sensor, to detect the switching of the presence or absence of the outer peripheral portion of the rotating substrate. The detection system according to the embodiment determines the eccentric direction and the amount of eccentricity of the substrate with respect to the rotational center from the detection information, which is constituted of the combination of the phase of the rotator and the detecting positions. Accordingly, the detection system according to the embodiment can reliably detect the eccentric state of the substrate at low cost.

In the example illustrated in FIG. 1, the detectors are installed such that the optical paths of the optical sensors are parallel to the substrate. However, the installation state of the detectors is not limited to this. For example, the detectors may be installed such that the optical paths of the optical sensors have any given angle with respect to the substrate.

In the example illustrated in FIG. 1, the first detecting position and the second detecting position have the following positional relationship. The optical path of the optical sensor at the first detecting position and the optical path of the optical sensor at the second detecting position are parallel to one another. However, the relationship between the first detecting position and the second detecting position is not limited to this. It is only necessary that the first and second detecting positions have a distance of mutually different from the rotational center to a point where the switching of the presence or absence of the outer peripheral portion of the substrate is detected. Accordingly, the optical paths of the optical sensors at the first detecting position and the second detecting position may not be parallel to one another and may not be on the same plane.

The example illustrated in FIG. 1 uses the optical sensor as the detector. However, the configuration of the detector is not limited to this. The detector may be an ultrasonic sound wave sensor, a contact type sensor, or an imaging device such as a camera and a video.

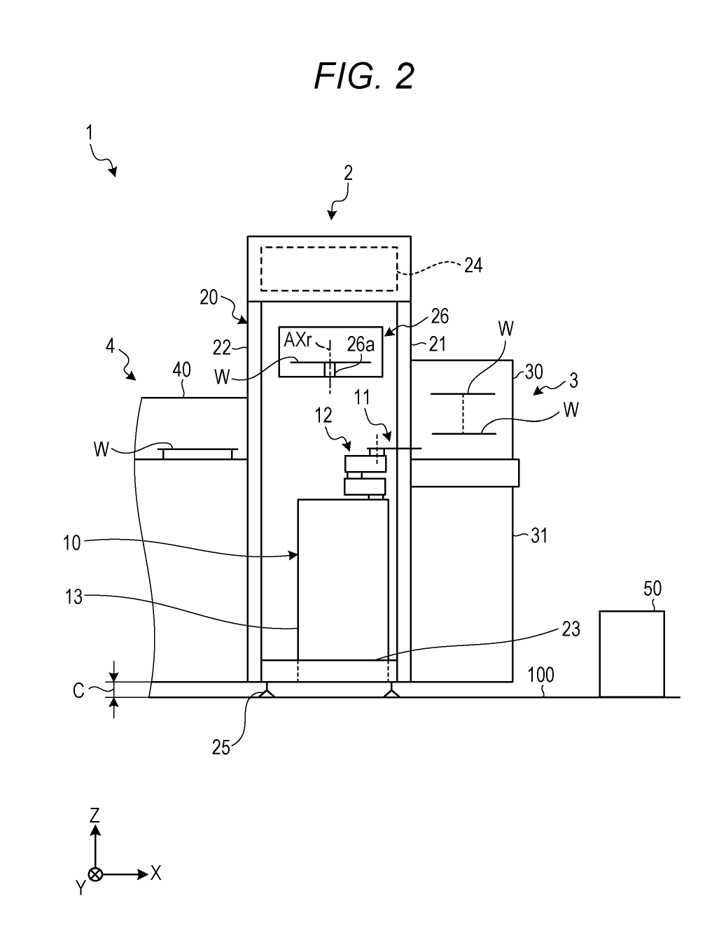

The “detectors” illustrated in FIG. 1 may be disposed at a prealigner device (rotator 26), which will be described later. In a detection system 1 according to the embodiment illustrated in FIG. 2, a detector 60 is disposed at a hand 11 of a robot 10. This configuration allows the detector 60 to easily move between different detecting positions. The following specifically describes the detection system 1 where the detector 60 is disposed at the hand 11 of the robot 10 with reference to FIG. 2.

FIG. 2 is a pattern diagram illustrating an arrangement of the detection system. For clear explanation, FIG. 2 illustrates a three-dimensional orthogonal coordinate system including a Z-axis that places a vertically upward direction as a positive direction and a vertically downward direction (that is, “vertical direction”) as a negative direction. Accordingly, a direction along the XY-plane refers to a “horizontal direction.” Such an orthogonal coordinate system may be illustrated in other drawings used in the following descriptions.

As illustrated in FIG. 2, the detection system 1 includes a substrate conveyor 2, a substrate supplier 3, and a substrate processor 4. The substrate conveyor 2 includes the robot 10 and a housing 20. The housing 20 internally disposes the robot 10. The substrate supplier 3 is disposed at one side surface 21 of the housing 20. The substrate processor 4 is disposed at another side surface 22 of the housing 20. The detection system 1 is installed on an installation surface 100.

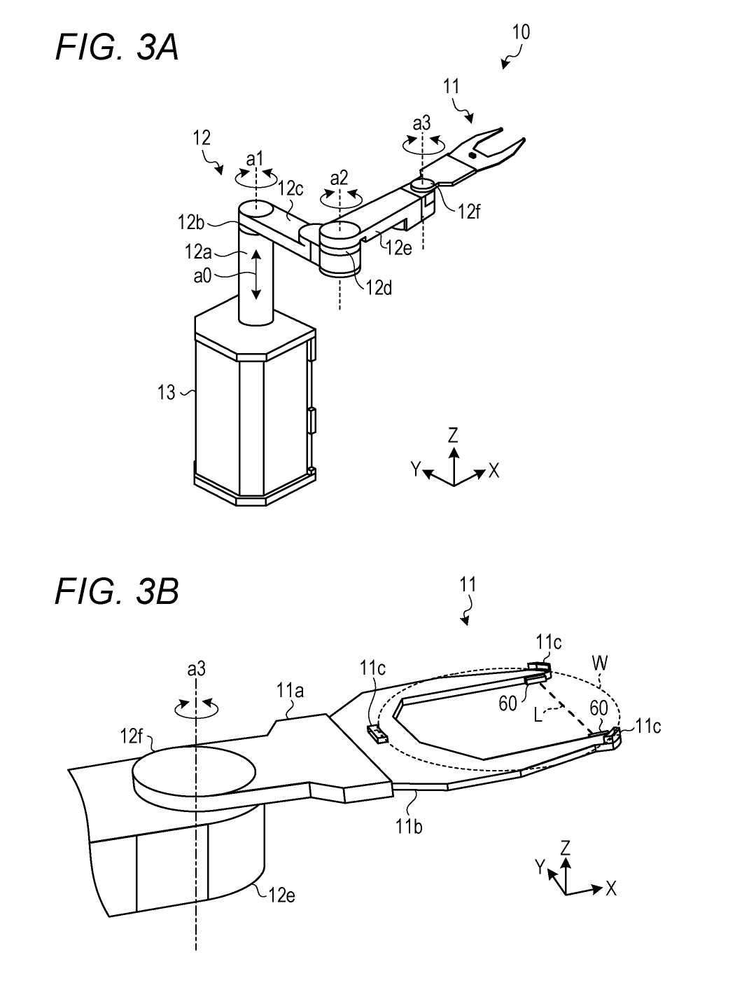

The robot 10 includes an arm portion 12 provided with the hand 11 that can hold a wafer W, which is an object to be carried. The arm portion 12 is supported by a base 13 and can move up and down and swing in the horizontal direction with respect to the base 13. The base 13 is installed on a base installation frame 23. The base installation frame 23 forms a bottom wall portion of the housing 20. Details of the robot 10 will be described later with reference to FIG. 3A.

The housing 20 is, what is called, and Equipment Front End Module (EFEM), which generates a down flow of clean air through a filter unit 24 disposed at an upper part. This down flow keeps the inside of the housing 20 in a high cleanliness state. At a bottom surface of the base installation frame 23, leg tools 25 are disposed. The leg tools 25 support the housing 20 with keeping a predetermined clearance C between the housing 20 and the installation surface 100.

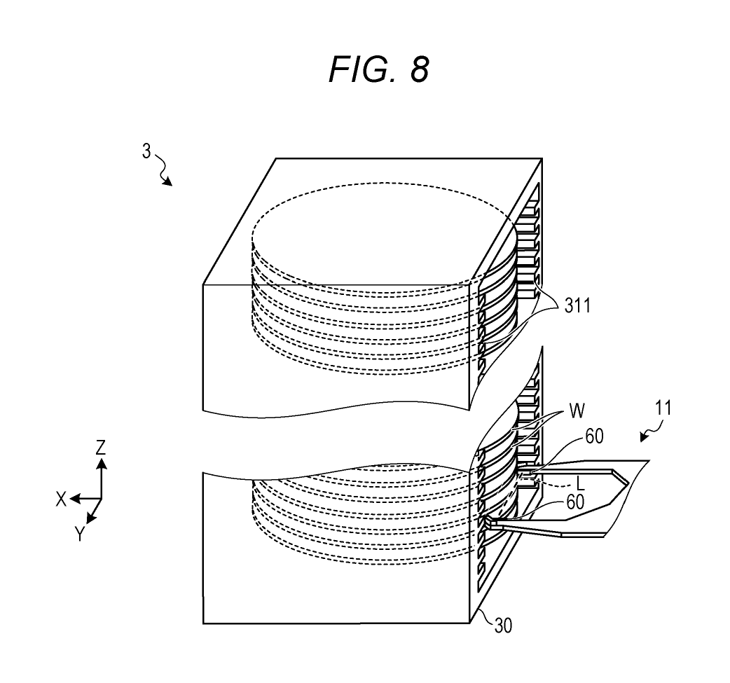

The substrate supplier 3 includes a FOUP 30, a FOUP opener (not illustrated), and a table 31 on which the FOUP 30 and the FOUP opener are placed. The FOUP 30 stores a plurality of wafers W (corresponding to the substrate in FIG. 1) in multiple stages in the height direction. The FOUP opener opens and closes a lid of the FOUP 30 to allow the wafer W in the housing 20 to be taken out. Incidentally, more than one pair of the FOUP 30 and the FOUP opener may be disposed with being spaced a predetermined distance from one another on the table 31 having a predetermined height. The details of the FOUP 30 will be described later with reference to FIG. 8.

The substrate processor 4 is a process processor that performs, on the wafer W, predetermined steps in the semiconductor manufacturing process, such as a cleaning step, a film formation step, and a photolithography step. The substrate processor 4 includes a process apparatus 40 which performs such predetermined process steps. The process apparatus 40 is disposed on the other side surface 22 of the housing 20 so as to, for example, be opposed to the substrate supplier 3 with placing the robot 10 between them.

FIG. 2 illustrates the case where the substrate supplier 3 and the substrate processor 4 are disposed to be opposed to each other as one example. However, the positional relationship between the substrate supplier 3 and the substrate processor 4 is not limited to this. The substrate supplier 3 and the substrate processor 4 can be disposed in any given positional relationship. For example, the substrate supplier 3 and the substrate processor 4 may be aligned on the same side surface of the substrate conveyor 2, or may be respectively disposed on two side surfaces that are not opposed to each other.

The rotator 26 such as a prealigner device, which centers the wafer W, is disposed at the inside of the housing 20. The rotator 26 includes a mounting base 26a for placing the wafer W. The mounting base 26a is disposed such that the wafer W is rotatable around an axis AXr that is parallel to the Z-axis.

The detection system 1 includes a control apparatus 50 at the outside of the housing 20. The control apparatus 50 is coupled to various devices inside of the housing 20 so as to transmit information to the devices such as the robot 10, the rotator 26, and the detector 60 that will be described later.

In the detection system 1 having such configuration, the robot 10 performs vertically moving operation and swing operation and takes out the wafer W inside of the FOUP 30. The robot 10 carries the extracted wafer W to the process apparatus 40 via the rotator 26. Then, the robot 10 again carries out and delivers the wafer W where the predetermined process has been performed by the process apparatus 40, and stores the processed wafer W into the FOUP 30 again.

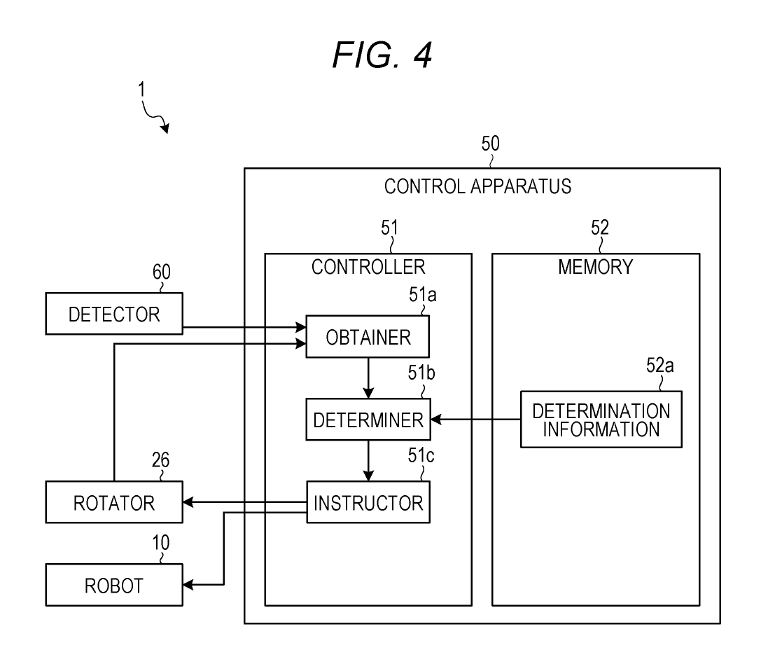

The control apparatus 50 controls operations by the coupled various devices. The control apparatus 50 is configured to include various devices such as a control device, an arithmetic processing device, and a storage device. The details of the control apparatus 50 will be described later with reference to FIG. 4.

FIG. 2 illustrates the control apparatus 50 having one housing. The control apparatus 50, for example, may include a plurality of housings which respectively correspond to the various devices to be controlled. Alternatively, the control apparatus 50 may be disposed inside of the housing 20.

The operation controls of the various operations of the robot 10, which are performed by the control apparatus 50, may be performed based on instruction data that is stored in the control apparatus 50 in advance. The instruction data may be obtained from a host device (not illustrated) communicatively coupled to the control apparatus 50 with one another. In this case, the host device may always monitor the state of the robot 10 (and each component of the robot 10).

The following describes the configuration of the robot 10 according to the embodiment with reference to FIG. 3A. FIG. 3A is a perspective view illustrating the configuration of the robot 10. As illustrated in FIG. 3A, the robot 10 includes the hand 11, the arm portion 12, and the base 13. The arm portion 12 includes an ascending/descending portion 12a, a joint portion 12b, a joint portion 12d, a joint portion 12f, a first arm 12c, and a second arm 12e.

The base 13 is, as described above, a base portion of the robot 10 installed on the base installation frame 23 (see FIG. 2). The ascending/descending portion 12a is slidably disposed in the vertical direction (Z-axis direction) from the base 13 (see a double-headed arrow a0 in FIG. 3A). The ascending/descending portion 12a moves up and down the arm portion 12 in the vertical direction.

The joint portion 12b is a joint rotating around an axis a1 (see the double-headed arrow around the axis al in FIG. 3A). The first arm 12c is rotatably coupled to the ascending/descending portion 12a via the joint portion 12b.

The joint portion 12d is a joint rotating around an axis a2 (see a double-headed arrow around the axis a2 in FIG. 3A). The second arm 12e is rotatably coupled to the first arm 12c via the joint portion 12d.

The joint portion 12f is a joint rotating around an axis a3 (see a double-headed arrow around the axis a3 in FIG. 3A). The hand 11 is rotatably coupled to the second arm 12e via the joint portion 12f.

A driving source (not illustrated) such as a motor is mounted to the robot 10. The joint portion 12b, the joint portion 12d, and the joint portion 12f each rotates based on driving of the driving source. The hand 11 is an end effector that holds the wafer W (see FIG. 2). The hand 11 is coupled to the joint portion 12f. This allows the hand 11 to rotate around the axis a3.

The following describes details of the configuration of the hand 11 according to a first embodiment with reference to FIG. 3B. FIG. 3B is a perspective view illustrating the configuration of the hand 11. As illustrated in FIG. 3B, the hand 11 is disposed at a tip portion of the second arm 12e via the joint portion 12f so as to be rotatable around the axis a3. The hand 11 includes a plate support portion 11a, a plate 11b, and lock portions 11c. The detectors 60 are disposed at the plate 11b.

The plate support portion 11a is coupled to the joint portion 12f and supports the plate 11b. That is, the plate support portion 11a is a member corresponding to a base portion of the hand 11. FIG. 3B exemplifies the plate 11b. The plate 11b has two tip portions and bifurcated at the tip side. However, the shape of the plate 11b is not limited to this.

The lock portion 11 c is a member for holding the wafer W on the hand 11 by locking the wafer W. This embodiment includes three pieces of the lock portions 11c at the positions illustrated in FIG. 3B so as to lock and hold the wafer W at the three points. The number of lock portions 11c is not limited to three. For example, four or more of the lock portions 11c may be disposed. FIG. 3B illustrates the wafer W held on the hand 11 by a dotted line.

The detector 60 is an optical sensor including a pair of a light projecting portion and a light receiving portion. The detectors 60 are, as illustrated in FIG. 3B as one example, disposed at the two tip portions (protrusions) of the tip side surface of the plate 11b so as to be opposed to one another. FIG. 3B illustrates a locus of a light projected from the light projecting portion as a detection line L. As long as the detector 60 has a configuration that can detect the switching of the presence or absence of the outer peripheral portion of the rotating wafer W, the detector 60 may be installed at any location. For example, the detector 60 may be installed at the rotator 26 (see FIG. 2).

The following describes the configuration of the detection system 1 according to the embodiment with reference to FIG. 4. FIG. 4 is a block diagram of the detection system according to the embodiment. FIG. 4 illustrates components used for explanation of the detection system 1 while omits to illustrate general components. The internal configuration of the control apparatus 50 is mainly described with reference to FIG. 4, and the explanation of the various devices which has been already described with reference to FIG. 2 may be simplified.

As illustrated in FIG. 4, the control apparatus 50 includes a controller 51 and a memory 52. The controller 51 includes an acquirer 51a, a determiner 51b, and an instructor 51c. The controller 51 controls the entire control apparatus 50. The acquirer 51a acquires the information including the switching of the presence or absence of the outer peripheral portion of the rotating wafer W (see FIG. 2) detected by the detectors 60 and the phase of the mounting base 26a (see FIG. 2) provided with the rotator 26, and then transmits the information to the determiner 51b.

The determiner 51b determines the eccentric state of the wafer W based on detection information. The detection information includes information on the phase of the mounting base 26a and the position of the detectors 60 when the presence and absence of the outer peripheral portion of the wafer W are switched. The eccentric state is determined based on determination information 52a. The determination information 52a is, for example, information including the relationship between the phase of the mounting base 26a and the distance from the axis AXr (see FIG. 2) to the outer circumference of the wafer W. This determination information 52a is stored in the memory 52 in advance.

The instructor 51c, based on the information from the determiner 51b, generates an operation signal for operating the various devices such as the robot 10 (see FIG. 2) and the rotator 26, and then outputs the operation signal to the various devices. The memory 52 is a storage device such as a hard disk drive or a non-volatile memory, and stores the determination information 52a. Since the contents of the determination information 52a have already been described, the description of the contents is omitted here.

The above-described description shows an example where the control apparatus 50 determines the eccentric state of the wafer W based on the preliminarily stored determination information 52a or similar information. Instead of this, the control apparatus 50 may obtain information used for the determination from the host device communicatively coupled to the control apparatus 50 with one another.

The following describes one example of a method for detecting the eccentric state of the wafer W by the detection system 1 according to the embodiment with reference to FIG. 5A to FIG. 5C. FIG. 5A illustrates detecting positions of the detection system. FIG. 5B illustrates an example of a relationship between the phase and the distance from the rotational center to the outer circumference of the wafer. FIG. 5C illustrates an example of the eccentric state of the wafer.

For easy understanding of the description, FIG. 5A illustrates an intersection point of the mounting surface of the wafer W on the mounting base 26a (see FIG. 2) and the axis AXr as a rotational center C0. An axis passing through the rotational center C0 and parallel to the X-axis is referred to as an axis X0. An axis passing through the rotational center C0 and parallel to the Y-axis is referred to as an axis Y0. For easy understanding of the eccentric state of the wafer W, a position of the outer peripheral portion of the wafer W when mounted on the mounting base 26a without eccentricity is indicated by the one-dot chain line.

The following description describes the rotation direction of the wafer W counterclockwise viewed from the positive direction of the Z-axis is referred to as the “positive direction.” In FIG. 5A, a rotation angle of the axis XO in the positive direction around the axis AXr referencing a part at the negative direction side of the X-axis with respect to the rotational center C0 is referred to as a “phase.” These indications may be used in other drawings used in the following description. FIG. 5A assumes that the wafer W is mounted on the mounting base 26a such that a principal surface of the wafer W is parallel to the XY-plane and the wafer W is rotated in the positive direction by the rotator 26.

As illustrated in FIG. 5A, the robot 10 (see FIG. 2), for example, approaches the hand 11 to the wafer W from the negative direction of the X-axis (arrow 202) such that the plate 11b and the XY-plane are parallel to one another and the detection line L and the axis Y0 are parallel to one another. In this case, the position of the detection line L in the Z-axis direction is decided so as to fall within the side surfaces of the wafer W, namely, between the two principal surfaces of the wafer W (between the front surface and the back surface of the wafer W).

The robot 10 moves the hand 11 to a position by which a distance between the rotational center C0 and the detection line L becomes a distance dl illustrated in FIG. 5A (hereinafter referred to as a “first detecting position”). Alternatively, the robot 10 moves the hand 11 to a position by which a distance between the rotational center C0 and the detection line L becomes a distance d2 (hereinafter referred to as a “second detecting position”). Then, the detector 60 detects the switching of the presence or absence of the outer peripheral portion of the wafer W at the first detecting position. Afterwards, the detector 60 detects the switching of the presence or absence of the outer peripheral portion of the wafer W at the second detecting position.

The second detecting position may be at the negative direction side of the X-axis with respect to the first detecting position. The distance d1 and the distance d2 are appropriately decided in advance from a size of the wafer W, an interval of the detectors 60, or a similar condition. Here, it is assumed that the change in the presence or absence of the outer peripheral portion of the wafer W detected by the detector 60 does not include information on a direction of the change, such as (presence→absence) and (absence→presence).

Here, at the respective first and second detecting positions illustrated in FIG. 5A, one rotation of the wafer W switches the presence or absence of the outer peripheral portion twice. FIG. 5B illustrates this twice switching change from (presence→absence) to (absence→presence) as detection points 203a and 204a by the white circles (solid lines) as one example. FIG. 5B also illustrates the change from (absence→presence) to (presence→absence) as detection points 203b and 204b by the white circles (dotted lines) as one example.

The two cases mutually differ in the state of the wafer W mounted on the mounting base 26a (“initial state”). That is, in these two cases, the amount of eccentricity of the wafer W to the rotational center C0 is the same while the eccentric direction differs. The detection points 203a and 203b are detected at the first detecting position. The detection points 204a and 204b are detected at the second detecting position.

It is known that the relationship between the phase of the rotating “circle” and “a distance” from “a single point other than a center of the inside of the circle” to “a distance of the outer circumference of the circle in a uniform direction” draws a “sine wave curve” vibrating placing a radius of the circle as its center. One cycle of this sine wave curve is 360°. An amplitude (half amplitude) is a distance from the center of the circle to a single point other than the center inside of the circle.

In this embodiment, the above-described circle corresponds to the outer peripheral portion of the wafer W. The single point other than the center inside of the circle corresponds to the rotational center C0. A distance from the rotational center C0 to the outer circumference of the circle in the uniform direction (negative direction of the X-axis) (a component of the distance from the rotational center C0 to the outer circumference of the wafer W in the uniform direction (negative direction of the X-axis) corresponds to a “distance d”, which will be described later. The amplitude corresponds to the amount of eccentricity of the wafer W with respect to the rotational center C0. Here, the distance d (first distance) means a distance from the rotational center C0 to the outer circumference of the circle projected on the axis X0. Therefore, in this embodiment, the determiner 51b estimates the sine wave curve by combination of the phase and the distance d when the presence or absence of the outer peripheral portion of the wafer W switches at the first and second detecting positions.

FIG. 5B illustrates a sine wave curve 205a (solid line) estimated from the detection points 203a and 204a and a sine wave curve 205b (dotted line) estimated from the detection points 203b and 204b. The horizontal axis in FIG. 5B is a phase of the rotating wafer W while the vertical axis is the distance d, which is already described above. The vertical axis in FIG. 5B shows a distance from the rotational center C0 corresponding to the radius of the wafer W as a distance R.

As illustrated in FIG. 5B, in a range of the phase 0° to 360°, the sine wave curve 205a has a concave type while the sine wave curve 205b has a convex type. Although having different phases, the sine wave curve 205a and the sine wave curve 205b have the same cycle (360°) and the same amplitude (distance G0). In view of this, the method for determining the eccentric state of the wafer W, which is describe later, is the same between the sine wave curve 205a and the sine wave curve 205b.

Accordingly, the following describes one example of the method for determining the eccentric state of the wafer W according to the embodiment using the sine wave curve 205a as an example. The method for determining the eccentric state is not limited to the following one example. The determiner 51b can determine the eccentric state of the wafer W based on the relationship between any given phase and the distance d in the sine wave curve 205a. For example, the determiner 51b may determine the eccentric state of the wafer W from a “nodal point” of the sine wave curve 205a where the distance d becomes the distance R, a “peak bottom” of the sine wave curve 205a in the positive direction of the vertical axis, or a similar condition.

FIG. 5B illustrates the phase of, for example, a “peak top” of the sine wave curve 205a in, for example, the positive direction of the vertical axis as the phase (360-θ0)°. In this case, the peak top proceeds by the phase θ0° by the rotation of the wafer W. The peak top in the initial state is in the direction of the phase θ0°.

FIG. 5B shows a difference between the distance d and the distance R at the peak top as the distance G0. This distance G0 is amplitude of the sine wave curve 205a. In view of this, the distance G0 is equal to the distance from the rotational center C0 to a center C1, that is, the amount of eccentricity of the wafer W with respect to the rotational center C0. FIG. 5B also shows the phase at the peak top of the sine wave curve 205b as the phase (360−θ1)°. In this case as well, the distance between the rotational center C0 and the center C1 is equal to the distance G0.

Accordingly, as illustrated in FIG. 5C, from the sine wave curve 205a, the center of C1 of the wafer W (black circle) is determined as being positioned away of the distance G0 in the phase θ0° direction viewed from the rotational center C0 in the initial state. FIG. 5C also illustrates the center C1 (white circle) and the outer peripheral portion (dotted line) of the wafer W determined as being positioned away of the distance G0 in the phase ∂1° direction viewed from the rotational center C0 in the initial state from the sine wave curve 205b. FIG. 5C exaggeratingly illustrates the position of the wafer W (center C1) with respect to the rotational center C0 for easy understanding of the description.

In the case where the rotational center C0 and the center C1 match, that is, in the case where the wafer W is not decentered, the amplitude of the sine wave curves 205a and 205b become 0. Accordingly, in FIG. 5B, the distance d becomes fixed at the distance R irrespective of the phase. In this case, regardless of the phase and the detecting positions, the switching of the presence or absence of the outer peripheral portion of the rotating wafer W is not detected. Accordingly, in the case where the switching of the presence or absence of the outer peripheral portion of the wafer W is not detected at the plurality of preliminarily determined points, the wafer W is determined as not eccentric.

Thus, with the detection system 1 according to the embodiment, the detectors 60 detect the switching of the presence or absence of the outer peripheral portion of the rotating wafer W at the plurality of points (first and second detecting positions) having different distances from the rotational center C0. Furthermore, the determiner 51b estimates the relationship between the distance from the axis AXr to the outer circumference of the wafer W and the phase of the mounting base 26a based on the detection information (phase of the mounting base 26a and the positions of the detectors 60 when the presence or absence of the outer peripheral portion of the wafer W is switched) corresponding to the first and second detecting positions. That is, the determiner 51b estimates the sine wave curve 205a or the sine wave curve 205b, which are drawn according to the relationship between the phase and the distance d. Accordingly, the determiner 51b can determine the eccentric state of the wafer W, that is, the eccentric direction and the amount of eccentricity of the wafer W with respect to the rotational center C0 by a simple process.

In the detection system 1 according to the embodiment, the robot 10 (see FIG. 2) moves the detectors 60 disposed at the hand 11 (see FIG. 3B) to change the detecting positions. This allows detecting the eccentric state of the wafer W with one (a pair of) sensors. This allows reducing the number of sensors, thus ensuring reduction of facility cost.

Here, from the four-point “phases and the distances d” (hereinafter referred to as “detected data”), the sine wave curve 205a or the sine wave curve 205b is estimated. However, insofar as three or more detected data including at least two-point detected data corresponding to the different distances d are provided, the sine wave curve 205a or the sine wave curve 205b can be estimated.

For example, the sine wave curve 205a shown in FIG. 5B can be estimated from the two detection points 203a and the one detection point 204a or the one detection point 203a and the two detection points 204a. The number of points of the detected data may be taken more than four points so as to enhance accuracy of estimation of the sine wave curve 205a or the sine wave curve 205b.

The detector 60 may further detect the direction of change in the switching of the presence and absence of the outer peripheral portion of the wafer W. In this case, the determiner 51b can estimate the sine wave curve 205a or the sine wave curve 205b from at least two-point detected data (including the phase, the distance d, and the direction of change) corresponding to the different distances d.

Specifically, in FIG. 5B, the switching (with→none) of the presence or absence of the outer peripheral portion of the wafer W corresponds to a negative “inclination” of the sine wave curve 205a or the sine wave curve 205b. On the other hand, the switching (none→with) of the presence or absence of the outer peripheral portion of the wafer W corresponds to a positive inclination of the sine wave curve 205a or the sine wave curve 205b. Accordingly, insofar as at least two-point different detected data corresponding to the different distances d are provided, the sine wave curve 205a or the sine wave curve 205b can be estimated from the phase, the detecting position, and the inclination. For example, the sine wave curve 205a shown in FIG. 5B can be estimated from the one detection point 203a and the one detection point 204a.

In FIG. 5A, detection is performed configuring the detection line L parallel to the respective XY-plane and Y-axis. However, the orientation of the detection line L is not limited to this, any given orientation can be set. The detectors 60 may be disposed at the respective hands 11 of the robot 10 that has a plurality of arms, such as a dual-arm robot. In this case, the switching of the presence or absence of the outer peripheral portion of the wafer W at the points having the different distances d can be simultaneously detected. In view of this, the eccentric state of the wafer W can be determined in a short time.

FIG. 5A exemplifies the case where the detectors 60 are the optical sensors. However, the detectors 60 may be imaging devices such as a still camera or a video camera. In this case, the detectors 60 may further detect the orientation of the wafer W from, for example, a mark or a predetermined shape that the wafer W has.

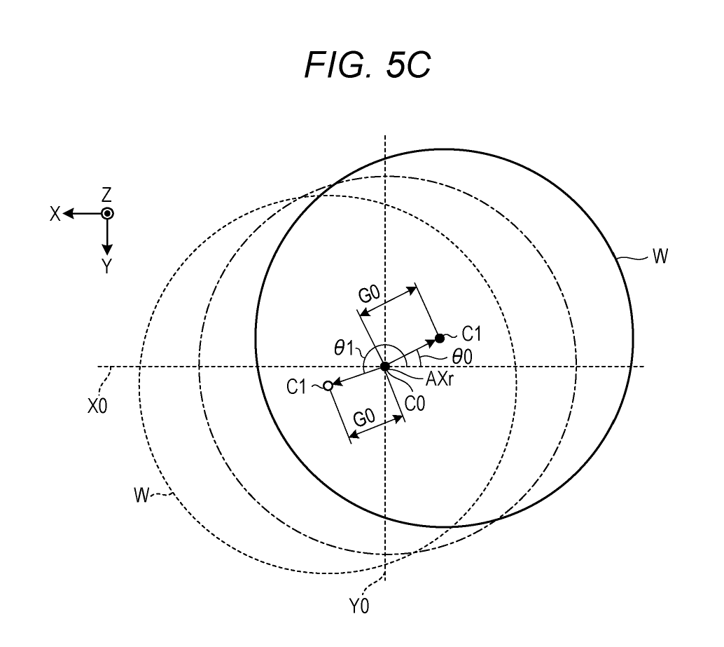

Meanwhile, in the example illustrated in FIG. 5A, the first and second detecting positions are preliminarily determined from the size of the wafer W, the interval between the detectors 60, or a similar specification. However, the method for deciding the detecting positions is not limited to this example. The following describes a (first) modification of the detection method with reference to FIG. 6. FIG. 6 illustrates the (first) modification of the detection method.

With the detection method according to the (first) modification, the determiner 51b decides any of the first and the second detecting positions based on the position of the detectors 60 (see a distance d0 in FIG. 6) when the detectors 60 detect the outer peripheral portion of the wafer W first. The robot 10 arranges the detectors 60 at the decided detecting positions. In this case, the determiner 51b may decide the position corresponding to the distance d0 as the first detecting position.

This configuration allows reducing an interference by the hand 11 moving in the positive direction of the X-axis and the wafer W in FIG. 6. When detecting the distance d0 while rotating the wafer W, even if the amount of eccentricity of the wafer W is large, such interference can be reliably reduced.

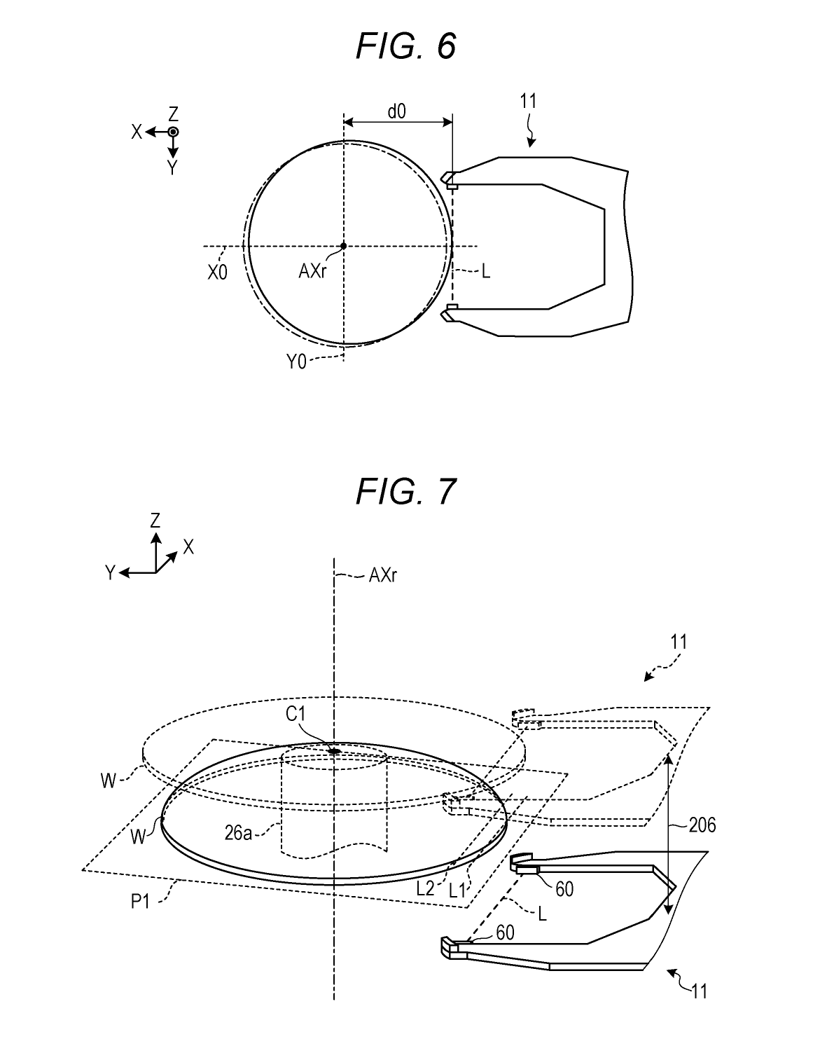

In the example illustrated in FIG. 5A, the wafer W is held parallel to the XY-plane. Related to this, the wafer W placed on the mounting base 26a (see FIG. 2) may generate bending in the Z-axis direction. In this case, the detector 60 detects the outer peripheral portion of the bent wafer W. The following describes a (second) modification of the detection method with reference to FIG. 7. FIG. 7 illustrates the (second) modification of the detection method.

In the example illustrated in FIG. 7, the wafer W placed on the mounting base 26a has a so-called dome shape gradually bent from the center C1 to the outer peripheral portion. FIG. 7 illustrates the unbent wafer W and the hand 11 that detects the outer peripheral portion of the wafer W by the dotted lines.

In the case where the wafer W cannot be detected at the position of the dotted lined hand 11 illustrated in FIG. 7, the robot 10 (see FIG. 2) moves the hand 11 in the direction along the axis AXr (for example, the negative direction of the Z-axis) to detect the presence or absence of the wafer W (arrow 206). In this case, the positions of the detectors 60 (hand 11) where the wafer W switches from present to absent becomes the position of the outer peripheral portion of the wafer W in the Z-axis direction. The robot 10 arranges the detectors 60 at the hand 11 at the position in the Z-axis direction.

This configuration allows the detectors 60 to detect the outer peripheral portion of the wafer W even if the wafer W is bent. Detecting the presence or absence of the wafer W by causing the dotted line hand 11 illustrated in FIG. 7 to move not only in the negative direction of the Z-axis but also in the positive direction of the Z-axis allows detecting the outer peripheral portion of the warped wafer W.

The detection method according to the (second) modification can estimate the position of the outer peripheral portion in the Z-axis direction at any given distance from the axis AXr. Specifically, the detectors 60 detect the outer peripheral portion of the wafer W at two positions having different distances from the axis AXr. Then, the determiner 51b estimates that the whole circumference of the outer peripheral portion of the wafer W is on a plane (see P1 in FIG. 7) including the two detection lines L (see L1 and L2 in FIG. 7), which are positions where the outer peripheral portion is detected.

By combining the position of the outer peripheral portion of the wafer W thus estimated with the phase information of the mounting base 26a (see FIG. 2), even at the bent or warped wafer W, the position of the outer peripheral portion of the wafer W with respect to any given phase can be determined. This allows easily detecting the outer peripheral portion of the wafer W.

The above-described embodiment describes an example where the detector 60 detects the eccentric state of the wafer W. However, the detector 60 may be configured so as to detect another detection target. The following describes the case where the detector 60 detects how the plurality of wafers W is housed in the FOUP 30 as one example with reference to FIG. 8. FIG. 8 illustrates another detection example of the detectors.

As illustrated in FIG. 8, the substrate supplier 3 includes the FOUP 30. The FOUP 30 has groove portions 311. The groove portions 311 can hold the wafers W formed in the Z-axis direction in, for example, the horizontal direction. The FOUP 30 houses the plurality of wafers W in multiple stages in the Z-axis direction. FIG. 8 illustrates a state where the FOUP 30 internally houses the plurality of wafers W.

The robot 10 (see FIG. 2) scans the tip of the hand 11 in the Z-axis direction at a predetermined position. Then, detectors 60 detect the presence or absence of the outer peripheral portion of the wafer W by a criterion of whether the peripheral edge portion of the wafer W blocks the detection line L or not. That is, the detector 60 is a mapping sensor that performs a so-called mapping operation to detect the position of the wafer W and the number of wafers W.

Thus, the detector 60 can be used not only for detection of eccentricity of the wafer W but also for the mapping operation. Accordingly, the detection system 1 can detect a plurality of detection targets using the detectors 60, thus allowing ensuring the reduction of the facility cost. The FOUP 30 is not limited to the configuration exemplified in FIG. 8. Insofar as the FOUP 30 can house the plurality of wafers W, the FOUP 30 may be configured by any form.

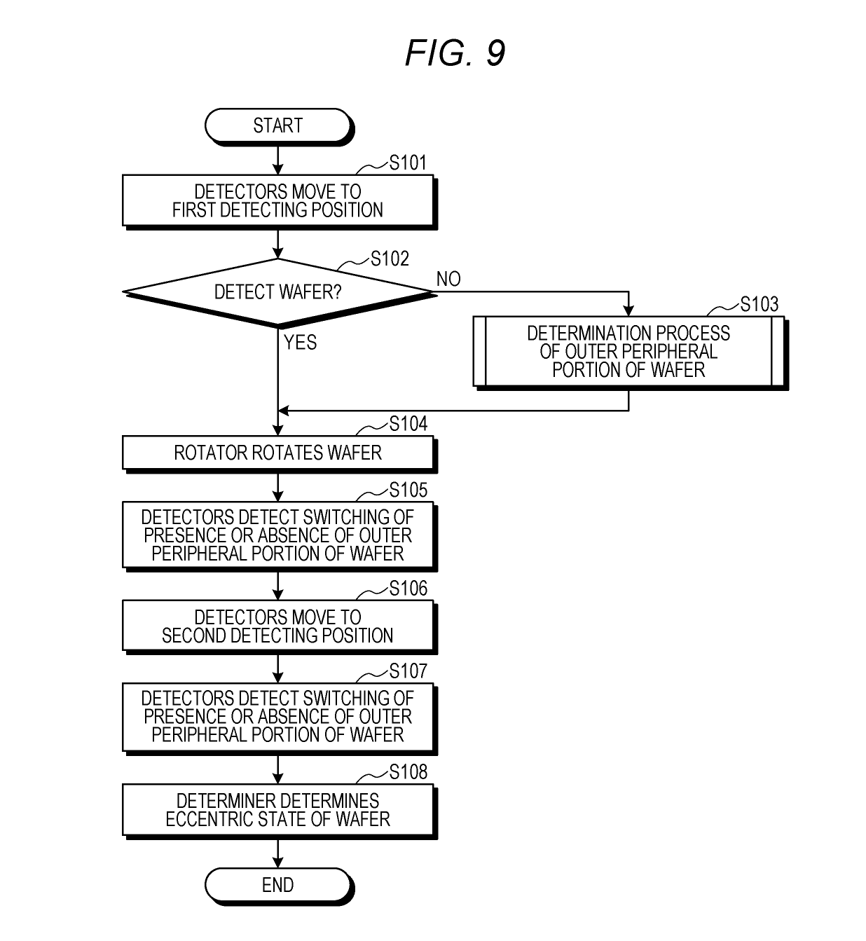

The following describes the process procedure performed by the detection system 1 according to the embodiment with reference to FIG. 9. FIG. 9 is a flowchart illustrating the process procedure performed by the detection system according to the embodiment. FIG. 9 describes the case where the detectors 60 perform a detection process at the first detecting position and then the rotator 26 starts rotating. Instead of this, the rotator 26 may start rotating before Step S101.

As described in FIG. 9, when the detectors 60 move to the first detecting position (Step S101), the determiner 51b determines whether the outer peripheral portion of the wafer W is detected or not (Step S102). When detecting the outer peripheral portion of the wafer W (Yes at Step S102), the rotator 26 rotates the wafer W (Step S104). If the wafer W is not bent or warped, Step S102 may be omitted.

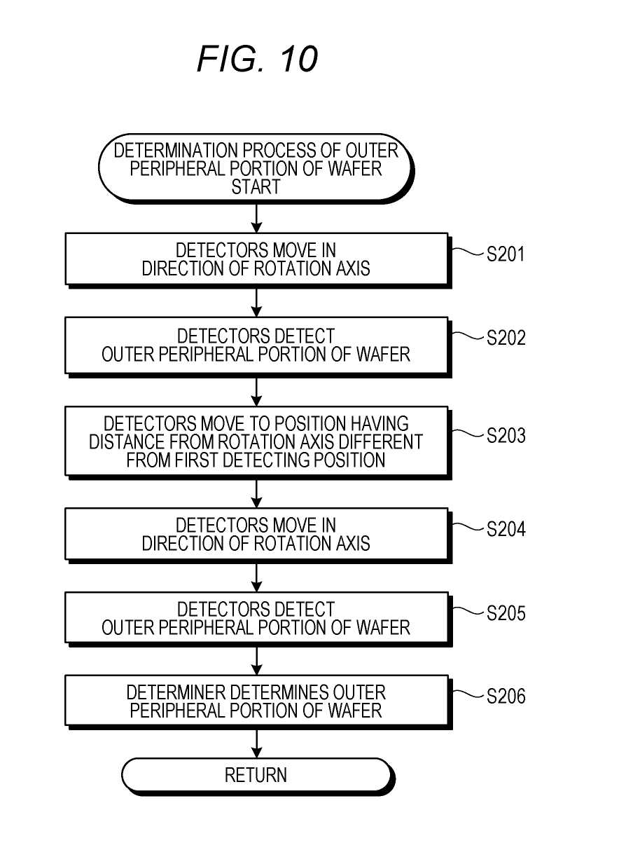

When not detecting the outer peripheral portion of the wafer W at Step S102 (No at Step S102), the detection system 1 performs a determination process of the outer peripheral portion of the wafer W (Step S103). Detailed process procedure for the determination process of this outer peripheral portion will be described later with reference to FIG. 10.

Next, when the detectors 60 detect the switching of the presence or absence of the outer peripheral portion of the wafer W (Step S105), the robot 10 moves the detectors 60 to the second detecting position (Step S106). Then, the detectors 60 detect the switching of the presence or absence of the outer peripheral portion of the wafer W (Step S107). The determiner 51b determines the eccentric state of the wafer W (Step S108). Then, this process is terminated.

In this case, the rotator 26 may continuously rotate from Step S104 through Step S107. Alternatively, the rotator 26 once aborts the rotation at the completion of Step S105 and may resume the rotation at the completion of Step S106.

Next, the following describes the detailed process procedure for the determination process of the outer peripheral portion of the wafer shown at Step S103 in FIG. 9 with reference to FIG. 10. FIG. 10 is a flowchart illustrating a process procedure for determination of the outer peripheral portion of the wafer.

The detectors 60 move in a direction of the rotation axis (axis AXr) (Step S201). The detectors 60 then detect the outer peripheral portion of the wafer W (Step S202). Then, the detectors 60 move to a position having a distance from the rotation axis different from the first detecting position (Step S203). The detectors 60 then move in the direction of the rotation axis (Step S204).

Next, the detectors 60 detect the outer peripheral portion of the wafer W (Step S205). Furthermore, the determiner 51b determines the outer peripheral portion of the wafer W (Step S206). Then, the process returns. Here, the determination of the outer peripheral portion means a process of identifying a predetermined plane based on the position of the detection line L at Steps S202 and S204 and a process of estimating the presence of the outer peripheral portion of the wafer W on the plane.

As described above, the detection system according to one aspect of the embodiment includes the rotator, the detectors, and the determiner. The rotator rotates the mounting base where the circular substrate is placed around its rotation axis. The detectors detect the presence or absence of the outer peripheral portion of the rotating substrate at the plurality of respective detecting positions having different distances from the rotation axis. The determiner determines the eccentric state of the substrate based on the detection information. The detection information is constituted of a combination of the phase of the mounting base (the rotator) when the presence or absence of the outer peripheral portion is switched and the detecting positions.

Thus, the detection system according to the embodiment determines the eccentric direction and the amount of eccentricity of the substrate with respect to the rotational center using a low-price sensor such as the optical sensor. Accordingly, the detection system (detection method) according to the embodiment can reliably detect the eccentric state of the substrate at low cost.

The above-described embodiments describe the case where one (a pair of) detectors are disposed at the tip portion of the one hand as an example. However, the number of detectors is not limited to one but may be plural. An installation site of the detector is not limited to the tip portion of the hand but may be, for example, a position other than the hand such as the rotator.

The above-described embodiments describe the case where the detector is fixedly installed as an example. However, the detector may be movable driven by, for example, a predetermined power source. In this case, the detector may detect the presence or absence of the outer peripheral portion of the substrate at a plurality of positions while moving.

The above-described embodiments are described using a single armed robot as an example. However, the detection system and the detection method according to the embodiment may be applied to a multi-arm robot having equal to or more than two arms. The plurality of hands may be disposed at the tip portion of one arm.

The above-described embodiments describe the case where workpiece, which is the detection target, is the substrate and the substrate is mainly the wafer as an example. However, the detection system and the detection method according to the embodiments are applicable to workpiece or a substrate of any given type. The workpiece, which is the detection target, needs not to be the substrate as long as the workpiece has a shape partially or wholly matches the circumference of the rotation axis.

Further effects and modifications can be easily made by those skilled in the art. Therefore, the disclosure in its broader aspects is not limited to the specific details and representative embodiments shown and described above. Accordingly, various modifications may be made without departing from the spirit or scope of the overall concept defined by the accompanying claims and their equivalents.

The detector 60 corresponds to one example of detecting means, and the determiner 51b corresponds to one example of determining means.

The embodiment of this disclosure may be the following first to sixth detection systems and the first detection method. The first detection system includes a rotator that causes a mounting base where a circular substrate is to be placed to rotate around a rotation axis, a detector that detects presence or absence of an outer peripheral portion of the rotating substrate at a plurality of respective detecting positions having different distances from the rotation axis, and a determiner that determines an eccentric state of the substrate based on detection information. The detection information is a combination of a phase of the mounting base when the presence or absence of the outer peripheral portion is switched and the detecting positions.

In the second detection system according to the first detection system, the determiner determines the eccentric state including an eccentric direction and an amount of eccentricity of the substrate. The determination is performed by estimating a relationship between a distance from the rotation axis to an outer circumference of the substrate and the phase based on the detection information where the detecting positions are different from one another.

The third detection system according to the first or the second detection system further includes a robot that has a hand, and the detector is disposed on the hand to detect the outer peripheral portion of the substrate from a side surface of the substrate.

In the fourth detection system according to the third detection system, the robot causes the detector to detect a position of the outer peripheral portion in a rotation axis direction by causing the hand to move in the rotation axis direction at the detecting position. The robot arranges the detector at the detected position in the rotation axis direction.

In the fifth detection system according to the third or the fourth detection system, the robot causes the detector to be positioned at the detecting position decided based on a position where the detector detects the outer peripheral portion first by the robot causing the hand to approach from an outside of the outer peripheral portion to the substrate.

In the sixth detection system according to any of the third to the fifth detection systems, the detector is a sensor used for detection of a housing state of the substrate in a housing container.

A first detection method includes: a step of causing a mounting base where a circular substrate is to be placed to rotate around a rotation axis; a step of detecting presence or absence of an outer peripheral portion of the rotating substrate at a plurality of respective detecting positions having different distances from the rotation axis; and a step of determining an eccentric state of the substrate based on detection information. The detection information is a combination of a phase of the mounting base when the presence or absence of the outer peripheral portion is switched and the detecting positions.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A detection system, comprising:
a rotator that causes a mounting base where a circular substrate is to be mounted to rotate around a rotation axis;
a detector that detects presence or absence of an outer peripheral portion of the rotating substrate at a plurality of respective detecting positions having different distances from the rotation axis; and
a determiner that determines an eccentric state of the substrate based on detection information, the detection information being a combination of a phase of the mounting base when the presence or absence of the outer peripheral portion is switched and the detecting positions.

2. The detection system according to claim 1, wherein
the determiner determines the eccentric state including an eccentric direction and an amount of eccentricity of the substrate by estimating a relationship between a distance from the rotation axis to an outer circumference of the substrate and the phase based on the detection information corresponding to the plurality of different detecting positions.

3. The detection system according to claim 2, wherein
the detector detects switching of the presence or absence of the outer peripheral portion of the substrate at the plurality of detecting positions, and
the determiner estimates a sine wave curve by combinations of the phases when the presence or absence of the outer peripheral portion of the substrate is switched at the plurality of detecting positions and first distances, the first distances being components of distances from the rotation axis to the outer circumference of the substrate in a uniform direction, and determines the eccentric state of the substrate based on the relationship between the phase and the first distance of the sine wave curve.

4. The detection system according to claim 3, wherein
the detector further detects a direction of change in the switching of the presence or absence of the outer peripheral portion of the substrate, and
the determiner estimates the sine wave curve based on the phase, the first distance, and the direction of change when the presence or absence of the outer peripheral portion of the substrate is switched at the plurality of detecting positions.

5. The detection system according to claim 1, further comprising
a robot that has a hand, wherein
the detector is disposed on the hand, the detector detecting the outer peripheral portion of the substrate from a side surface of the substrate.

6. The detection system according to claim 2, further comprising
a robot that has a hand, wherein
the detector is disposed on the hand, the detector detecting the outer peripheral portion of the substrate from a side surface of the substrate.

7. The detection system according to claim 5, wherein
the robot causes the detector to detect a position of the outer peripheral portion in a direction along the rotation axis by causing the hand to move in the direction along the rotation axis at the detecting position, the robot arranging the detector at the detected position in the direction along the rotation axis.

8. The detection system according to claim 6, wherein
the robot causes the detector to detect a position of the outer peripheral portion in a direction along the rotation axis by causing the hand to move in the direction along the rotation axis at the detecting position, the robot arranging the detector at the detected position in the direction along the rotation axis.

9. The detection system according to claim 5, wherein
the determiner decides any of the detecting positions based on a position where the detector detects the outer peripheral portion first by the robot causing the hand to approach from an outside of the outer peripheral portion to the substrate, and
the robot arranges the detector at the decided detecting position.

10. The detection system according to claim 6, wherein
the determiner decides any of the detecting positions based on a position where the detector detects the outer peripheral portion first by the robot causing the hand to approach from an outside of the outer peripheral portion to the substrate, and
the robot arranges the detector at the decided detecting position.

11. The detection system according to claim 7, wherein
the determiner decides any of the detecting positions based on a position where the detector detects the outer peripheral portion first by the robot causing the hand to approach from an outside of the outer peripheral portion to the substrate, and
the robot arranges the detector at the decided detecting position.

12. The detection system according to claim 8, wherein
the determiner decides any of the detecting positions based on a position where the detector detects the outer peripheral portion first by the robot causing the hand to approach from an outside of the outer peripheral portion to the substrate, and
the robot arranges the detector at the decided detecting position.

13. The detection system according to claim 5, wherein
the detector detects the outer peripheral portion of the substrate at two positions having different distances from the rotation axis, and
the determiner estimates that a whole circumference of the outer peripheral portion of the substrate is present on a plane corresponding to a position where the outer peripheral portion is detected.

14. The detection system according to claim 5, wherein
the detector is a sensor used for detection of a housing state of the substrate in a housing container.

15. The detection system according to claim 7, wherein
the detector is a sensor used for detection of a housing state of the substrate in a housing container.

16. The detection system according to claim 9, wherein
the detector is a sensor used for detection of a housing state of the substrate in a housing container.

17. A detection method, comprising:
causing a mounting base where a circular substrate is to be mounted to rotate around a rotation axis;
detecting presence or absence of an outer peripheral portion of the rotating substrate at a plurality of respective detecting positions having different distances from the rotation axis; and
determining an eccentric state of the substrate based on detection information, the detection information being a combination of a phase of the mounting base when the presence or absence of the outer peripheral portion is switched and the detecting positions.

18. A detection system, comprising:
detection means for detecting presence or absence of an outer peripheral portion of a substrate rotating around a rotation axis at a plurality of respective detecting positions having different distances from the rotation axis; and
determination means for determining an eccentric state of the substrate based on detection information, the detection information being a combination of a phase of the mounting base when the presence or absence of the outer peripheral portion is switched and the detecting positions.
